(19) United States
(12) Patent Application Publication
(10) Pub. No.: US 2022/0252795 A1
(43) Pub. Date: Aug. 11, 2022

(54) FIBER OPTIC CONNECTOR

(71) Applicant: Senko Advanced Components, Inc., Marlborough, MA (US)

(72) Inventor: Paul Newbury, Ashland, MA (US)

(21) Appl. No.: 17/051,146

(22) PCT Filed: Oct. 26, 2020
(86) PCT No.: PCT/US20/57393

§ 371 Date: Oct. 27, 2020

Related U.S. Application Data
(60) Provisional application No. 62/925,886, filed on Oct. 25, 2019.

(51) Int. Cl. G02B 6/38

(52) U.S. Cl. CPC G02B 6/3871; G02B 6/3893

(57) ABSTRACT

A fiber optic connector kit includes a fiber optic connector, a plug frame, a first front body and a second front body. The fiber optic connector has a back body and a ferrule. The plug frame attaches to the back body of the fiber optic connector, and has a plug frame connector. The first and second front bodies matingly connect with first and a second types of fiber optic receptacles, respectively. The first front body includes a first front body connector that connects to the plug frame connector to connect the first front body to the plug frame. The second front body includes a second front body connector that connects to the plug frame connector to connect the second front body to the plug frame.

### CROSS-REFERENCE TO RELATED APPLICATION

This application claims priority to International Application No. PCT/US2020/57393, filed Oct. 26, 2020, which claims priority to U.S. Provisional App. No. 62/925,886, filed Oct. 25, 2019, the entireties of which is hereby incorporated by reference.

### FIELD

The present disclosure generally relates to fiber optic connections, and, more specifically, to a fiber optic connector.

### BACKGROUND

Optical connectors are used within optical communication networks to interconnect optical cables to optical devices or other optical cables. Optical connections typically involve two optical connectors connected together. These optical connectors typically include housings that mate with one another to form the optical connection. In the field, there are different, commonly used connections for fiber optic connectors.

### SUMMARY

In one aspect, a fiber optic connector kit comprises a fiber optic connector having a back body and a ferrule supported by the back body and configured to form an optical connection. A plug frame is configured to attach to the back body of the fiber optic connector. The plug frame has a plug frame connector thereon. A first front body is configured for mating connection with a first type of fiber optic receptacle. The first front body includes a first front body connector configured to connect to the plug frame connector to connect the first front body to the plug frame. A second front body is configured for mating connection with a second type of fiber optic receptacle. The first and second front bodies have different mating structure for connection to the first type of fiber optic receptacle and the second type of fiber optic receptacle, respectively. The second front body includes a second front body connector configured for connection to the plug frame connector to connect the second front body to the plug frame.

In another aspect, a plug frame for a fiber optic connector comprises a plug frame body configured to attach to the fiber optic connector. The plug frame body defines a ferrule lumen sized and shaped to receive a ferrule of the fiber optic connector when the plug frame body is attached to the fiber optic connector. At least one plug frame connector is configured to form a connection with a front body to connect the front body to the plug frame.

Other objects and features of the present disclosure will be in part apparent and in part pointed out hereinafter.

### BRIEF DESCRIPTION OF THE DRAWINGS

FIG. 1 is a top view of a fiber optic connector assembly according to one embodiment of the present disclosure;

FIG. 2 is an exploded view of the fiber optic connector assembly, with an outer shell of the assembly is surrounding a first front body of the assembly;

FIG. 3 is another exploded view of the fiber optic connector assembly, with the outer shell and front body spaced apart;

FIGS. 4 and 5 are side views of the front body and the outer shell being connected to a fiber optic connector of the fiber optic connector assembly;

FIG. 6 is a side view of a plug frame of the fiber optic connector assembly attached to the fiber optic connector;

FIG. 7 is a perspective of the plug frame;

FIG. 8 is a front view of the plug frame;

FIG. 9 is a perspective of the front body and the outer shell;

FIG. 10 is a front perspective of the front body;

FIG. 11 is a rear view of the front body;

FIG. 12 is a front view of the fiber optic connector assembly;

FIG. 13A is a cross-section of the fiber optic connector assembly;

FIG. 13B is an enlarged fragment of FIG. 13A;

FIG. 14 is a top view of another embodiment of a fiber optic connector assembly according to one embodiment of the present disclosure;

FIG. 15 is an exploded view of the fiber optic connector assembly of FIG. 14, with an outer shell of the assembly and a second front body of the assembly exploded forward;

FIG. 16 is another exploded view of the fiber optic connector assembly of FIG. 14, with the outer shell on the fiber optic connector and second front body exploded forward;

FIGS. 17 and 18 are side views of the second front body connected to a fiber optic connector of the fiber optic connector assembly of FIG. 14;

FIG. 19 is a perspective of the second front body and the outer shell of FIG. 14;

FIG. 20 is a front perspective of the second front body of FIG. 14;

FIG. 21 is a rear view of the second front body of FIG. 14;

FIG. 22 is a front view of the fiber optic connector assembly of FIG. 14.

FIG. 23A is a cross-section of the fiber optic connector of FIG. 14; and

FIG. 23B is an enlarged fragment of FIG. 23A.

Corresponding reference characters indicate corresponding parts throughout the drawings.

### DETAILED DESCRIPTION

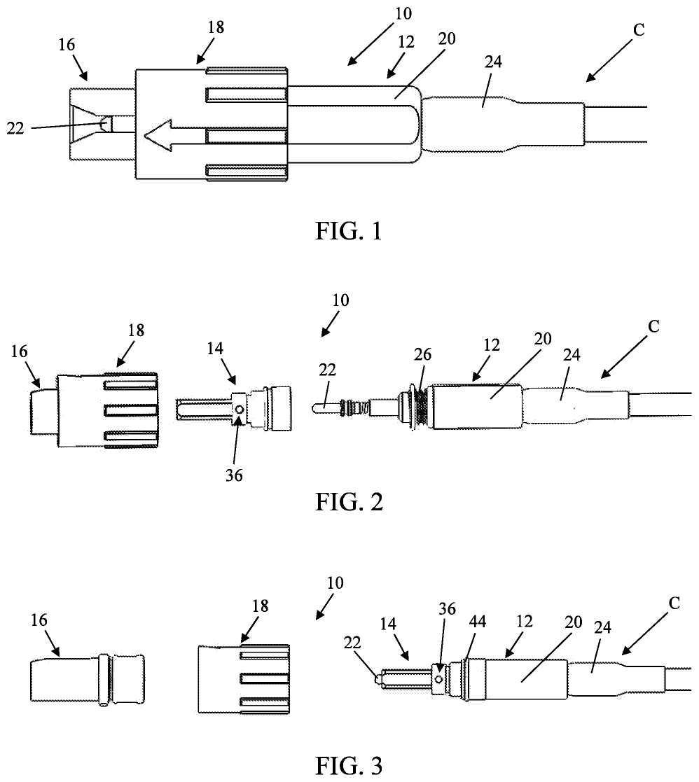

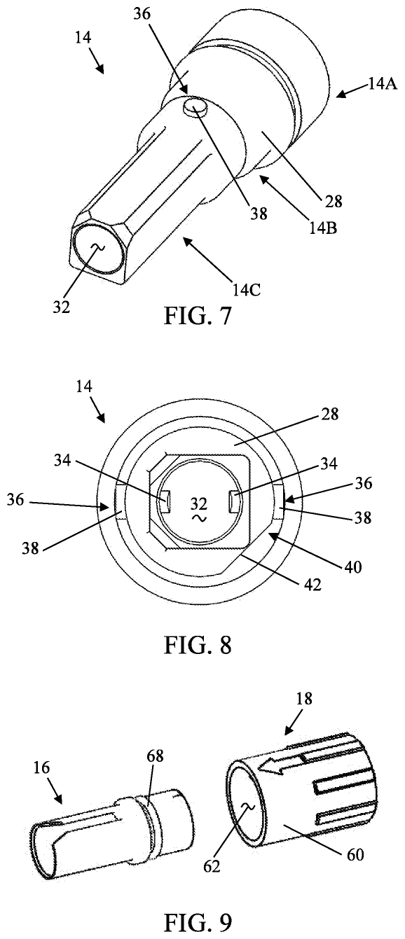

Referring to FIGS. 1-13B, a fiber optic connector assembly (which may also be considered a fiber optic connector) according to one embodiment of the present disclosure is generally indicated at reference numeral 10. The component parts (assembled or unassembled) of the fiber optic connector assembly 10 may also be herein referred to as a kit. The fiber optic connector assembly 10 is used to form a fiber optic connection with a fiber optic receptacle (not shown). As used herein, a fiber optic receptacle can be any device that connects to a fiber optic connector, including a fiber optic receptacle, a fiber optic adapter and a fiber optic connector. When the fiber optic receptacle and the fiber optic connector assembly 10 are coupled together, an optical connection (e.g., a fiber optic connection) is formed that enables communication (e.g., optical communication) between different fiber optic components (e.g., cables, devices, etc.) in an optical communications network. The fiber optic connector assembly 10 is attached to an end of a fiber optic cable C to couple the cable to the fiber optic receptacle, although other arrangements are within the scope of the present disclosure. Other configurations of the fiber optic connector assembly 10 are within the scope of the present disclosure. For example, the connector assembly could make electrical or other types of connections instead of or in addition to an optical connection.

The fiber optic connector assembly 10 includes a fiber optic connector 12, a plug frame 14, one or more front bodies or plugs 16 and/or an outer shell 18. The fiber optic connector 12 is attached to the end of the fiber optic cable C. The fiber optic connector 12 includes a back body or housing 20 and a ferrule 22 (broadly, a ferrule assembly). The ferrule is configured to form an optical connection. For example, the ferrule 22 may engage another ferrule (not shown) of the fiber optic receptacle to form the optical connection between the fiber optic connector assembly 10 and the fiber optic receptacle. The back body 20 supports the ferrule 22. The back body 20 is connected to the end of the fiber optic cable C. A heat shrink wrap 24 secures the back body 20 to the fiber optic cable C. The back body 20 includes external threads 26 (FIG. 2) for connecting (e.g., threading) the plug frame 14 to the back body 20.

The plug frame 14 is, broadly, a universal plug frame that is configured to attach to a plurality of different types of front bodies, such as first front body 16. Each type of front body mates with a specific type of fiber optic receptacle. Accordingly, the plug frame 14 allows different types of front bodies, such as first front body 16, to be attached thereto to enable to fiber optic connector assembly 10 to form a fiber optic connection with a fiber optic receptacle that corresponds to the attached front body. In this manner, the fiber optic connector assembly 10 can be configured for connecting to different types of fiber optic receptacles (each type of fiber optic receptacle having a different configuration or mating structure).

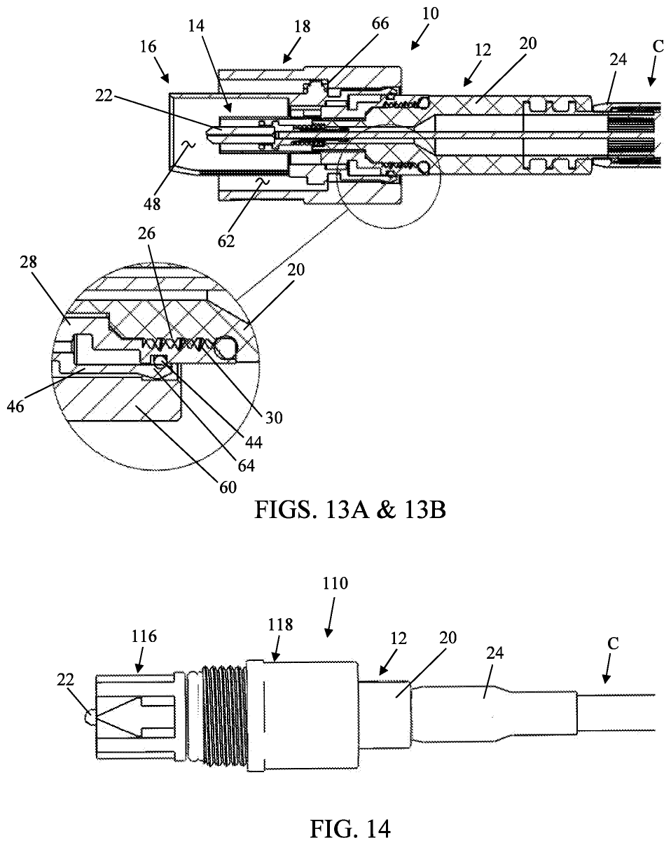

The plug frame 14 is configured to attach to the back body 20 of the fiber optic connector 12. The plug frame 14 includes a plug frame body or housing 28. The plug frame body 28 includes internal threads 30 (see, FIGS. 13A and 13B) for threading onto the external threads 26 of the back body 20. Other ways of attaching the plug frame 14 to the back body 20 are within the scope of the present disclosure. The plug frame 14 includes a proximal portion 14A, an intermediate potion 14B and a distal portion 14C. The intermediate portion 14B has a larger width (e.g., diameter) than the distal portion 14C and the proximal portion 14A has a larger width (e.g., diameter) than the intermediate portion 14B. The proximal portion 14A of the plug frame 14 is attached to the back body 20 of the fiber optic connector 12 (e.g., includes the internal threads 30). The distal portion 14C of the plug frame 14 is sized and shaped to be inserted into different front bodies and also into the fiber optic receptacle. The plug frame 14 defines a ferrule lumen 32 sized and shaped to receive the ferrule 22 of the fiber optic connector 12 when the plug frame (e.g., plug frame body 28) is attached to the fiber optic connector. The ferrule lumen 32 extends between the proximal and distal ends of the plug frame body 28. Thus, the ferrule lumen 32 has open proximal and distal ends. When the plug frame 14 is attached to the back body 20 of the fiber optic connector, the ferrule 22 is disposed in the ferrule lumen 32.

Desirably, the ferrule 22 extends through the open distal end of the ferrule lumen 32 (FIG. 6). The plug frame 14 supports (e.g., directly supports) the ferrule 22. In the illustrated embodiment, the plug frame 14 includes ferrule stops 34 (FIG. 8) disposed in the ferrule lumen 32. The ferrule stops 34 engage the ferrule 22 (FIG. 12) and to inhibit the ferrule from rotating (about a longitudinal axis) in the ferrule lumen. For example, the ferrule 22 may include slots or channels that receive the ferrule stops 34. By fixing the rotational position of ferrule 22, the alignment of the polished ferrule is set. A flat surface is cut on the rear of the protrusion defines a physical stop for the ferrule 22 so it does not move forward past a predetermined point. The plug frame 14 may include a gasket 44 (FIG. 13B), such as an O-ring, for forming a seal with the first front body 16, when the front body is attached to the plug frame. The gasket 44 extends circumferentially around the plug frame body. In the illustrated embodiment, the gasket 44 is located on the distal portion 14A. The distal portion 14A includes a circumferential channel that receives the gasket 44.

The plug frame 14 includes a plug frame connector 36 (broadly, at least one plug frame connector). The plug frame connector 36 is shaped and arranged to form a connection with the first front body 16 to connect or attach the front body to the plug frame 14. The plug frame connector 36 comprises a post 38 (broadly, a “protrusion”). The post 38 is attached to the plug frame body 28. The post 38 radially extends outward from the plug frame body 28. The post 38 is sized and shaped to be received by the first front body 16. In the illustrated embodiment, the post 38 has a cylinder or disk shape, although other configurations are within the scope of the present disclosure. The plug frame connector 36 is disposed generally near the center (e.g., longitudinal center) of the plug frame body 38, on the intermediate portion 14B. In the illustrated embodiment, the plug frame 14 includes two plug frame connectors 36, although more or fewer plug frame connectors are within the scope of the present disclosure. In the illustrated embodiment, the two plug frame connectors are located on generally opposite sides of the plug frame body 28 (e.g., about 180 degrees apart).

The plug frame 14 (e.g., plug frame body) includes a key 40 configured to permit the first front body 16 to be connected to the plug frame only when the front body is in a particular orientation relative to the plug frame. The key 40 of the plug frame 14 is configured to engage (e.g., mate) with a key (not shown) of the first front body 16 to align the front body and plug frame relative to one another. In the illustrated embodiment, the key 40 of the plug frame includes a generally planar surface 42. Other configurations of the keys of the plug frame 14 and the first front body 16 are within the scope of the present disclosure.

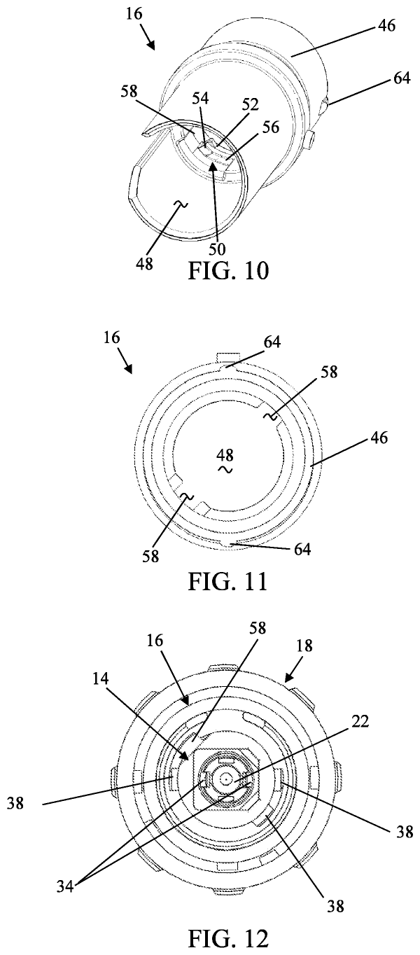

Referring to FIGS. 10 and 11, the first front body 16 is configured for mating connection with a type of fiber optic receptacle (e.g., a first type of fiber optic receptacle). The first front body 16 has a generally tubular shape. The first front body 16 has a generally cylindrical housing or wall 46. The first front body 16 defines a plug frame lumen 48 that receives the plug frame 14 when the front body is attached to the plug frame. In particular, the distal portion 14C of the plug frame 14 is disposed in the plug frame lumen 48 when the first front body 16 is attached to the plug frame. The first front body 16 is configured to connect or attach to the plug frame 14. The first front body 16 includes a front body connector 50 (e.g., a first front body connector) configured for connection to the plug frame connector 36 to connect the front body to the plug frame 14. The front body connector 50 includes a detent 52 configured to engage the plug frame connector 36 (e.g., post 38) to secure the first front body 16 to the plug frame 14. The detent 52 forms a snap-fit connection with the post 38. The detent 52 is resiliently deflectable. The detent 52 comprises a bayonet flange. The detent 52 includes a ramp 54 (e.g., ramp surface) that extends from an end of the detent toward a recess 56 of the detent. The recess 56 is sized is shaped to receive and hold the post 38. The first front body 16 (e.g., front body connector 50) includes or defines a lead-in channel 58 sized and shaped to receive the post 38. The lead-in channel 58 extends generally longitudinally (e.g., parallel to the longitudinal axis). The lead-in channel 58 has open proximal and distal ends. The lead-in channel 58 generally guides the post 38 toward the detent 52. The detent 52 and the lead-in channel 58 are located on the interior side of the wall 46. In the illustrated embodiment, the first front body 16 includes two front body connectors 50, although more or fewer front body connectors are within the scope of the present disclosure. In the illustrated embodiment, the two front body connectors 50 are located on generally opposite sides of the wall 46 (e.g., about 180 degrees apart). Each front body connector 50 connects to (e.g., engages with) one of the plug frame connectors 36.

In operation, to connect the first front body 16 to the plug frame 14, the front body is aligned with the plug frame using the keys 40. When the first front body 16 and the plug frame 14 are aligned, the post 38 are aligned with the channels 58. After the first front body 16 and the plug frame are aligned, the first front body 16 is moved (e.g., generally parallel to the longitudinal axis) proximally along the plug frame 14. As the first front body 16 moves proximally, the posts 38 move in the lead-in channels 58 toward the detent 52. The first front body 16 is moved proximally until the posts 38 move past (e.g., are distal of) the detents 52. In this position, the posts 38 are now out of the lead-in channels 58 and the first front body 16 can be rotated (about the longitudinal axis) relative to the plug frame 14. As the first front body 16 is rotated, the posts 38 engage the ramps 54 of the detents 52, deflecting the detents. Once the posts 38 become aligned with the recesses 46 of the detent 52, the detents return or snap-back to their undeformed (e.g., undeflected) state, securing the posts 38 in the recesses 46. Rotating the first front body 16 relative to the plug frame 14 moves the lead-in channel 58 out of alignment with the post 38 and moves the detent toward (and into engagement with) the post. In this manner, the first front body 16 is configured to be rotated relative to the plug frame 14 to releasably connect the front body (e.g., front body connector 50) to the plug frame (e.g., plug frame connector 36). To disconnect the first front body 16 from the plug frame 14, the first front body 16 is rotated in the opposite direction, disconnecting the post 38 and the detent 52 and moving the post into alignment with the lead-in channel 58. After, the first front body 16 is moved distally relative to the plug frame, thereby moving the post 38 through the lead-in channel 58 to remove the front body from the plug frame.

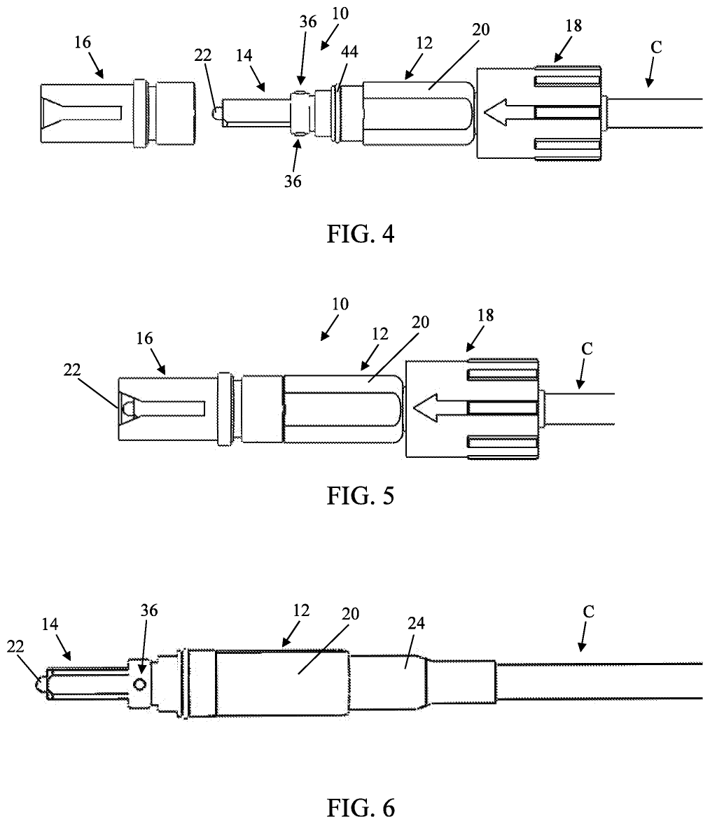

The outer shell 18 of the fiber is sized and shaped to fit over the first front body 16 and the fiber optic connector 12. The outer shell 18 has a generally tubular shape. The outer shell 18 includes has a generally cylindrical housing or wall 60. The outer shell 18 defines a front body lumen 62 that receives the first front body 16 and/or fiber optic connector 12 when the outer shell is attached to the front body. The outer shell 18 is configured to attach to or be received on the first front body 16. The first front body 16 includes one or more outer shell detents 64, that are resiliently deflectable, and engage the outer shell to secure the outer shell to the first front body 16. Specifically, the outer shell detents 64 inhibit proximal movement of the outer shell 18 relative to the first front body 16. The outer shell 18 also includes a shoulder 66 (FIG. 13A) that engages the first front body 16 to limit the distal movement of the outer shell 18 relative to the first front body 16. The outer shell 18 is configured to be secured to the fiber optic receptacle. The outer shell 18 includes securing structure (not shown, such as interior threads. for mechanically securing or connecting (e.g., threading) the outer shell 18 (broadly, the fiber optic connector assembly 10) to the fiber optic receptacle. The fiber optic receptacle includes corresponding securing structure, such as threads, for connecting to the securing structure of the outer shell 18. The outer shell detents 64 and shoulder 66 permit the outer shell 18 to rotate (about the longitudinal axis) relative to the first front body 16 while inhibit longitudinal movement of the outer shell relative to the front body. The first front body 16 may include a gasket 68 (FIG. 9), such as an O-ring, for forming a seal with the outer shell 18, when the outer shell is attached to the front body. The gasket 68 extends circumferentially around the first front body 16. In the illustrate embodiment, the gasket 68 is located in a circumferential channel of the first front body 16. To connect the outer shell 18 to the first front body 16, the outer shell is first moved proximally over the fiber optic connector 12 (FIG. 4). After, the first front body 16 is attached to the plug frame 14, as described above. After the first front body 16 is attached to the plug frame 14, the outer shell 18 is moved distally onto the first front body 16 (FIG. 5) until the outer shell detents 64 secure the outer shell to the front body.

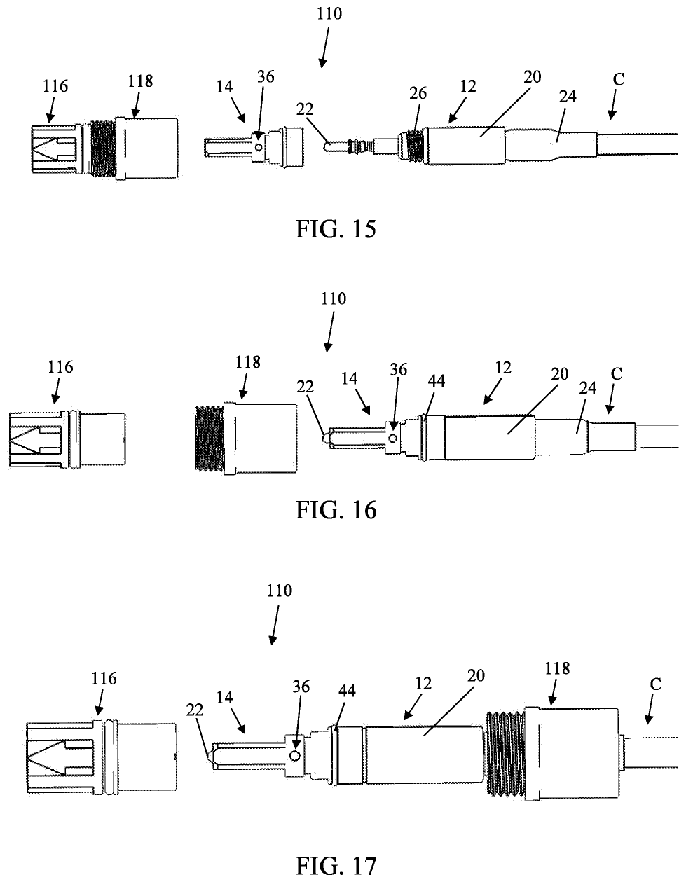

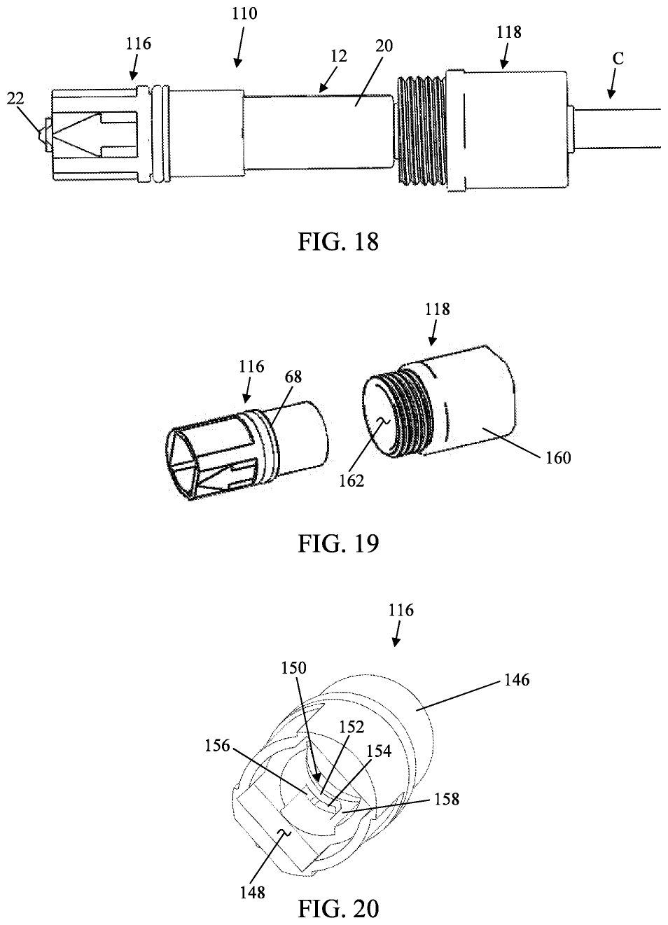

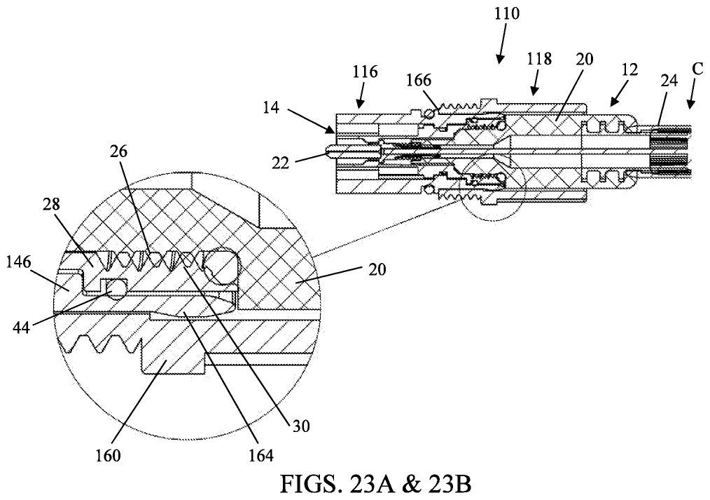

Referring to FIGS. 14-23B, another embodiment of the fiber optic connector assembly according to the present disclosure is generally indicated by reference numeral 110. Fiber optic connector assembly 110 is generally analogous to fiber optic connector assembly 10 and, thus, for ease of comprehension, where similar or analogous parts are used, reference numerals “100” units higher are employed. Likewise, where identical parts are used between fiber optic connector assemblies 110, 10, identical reference numerals are employed. Accordingly, unless clearly stated or indicated otherwise, the above descriptions regarding fiber optic connector assembly 10 also apply to fiber optic connector assembly 110.

Fiber optic connector assembly 110 includes the fiber optic connector 12 and the plug frame 16, as described above. In addition, the fiber optic connector assembly 110 includes a plug or front body 116 (e.g., a second front body) and/or an outer shell 118, that are different from first front body 16 and outer shell 18. As mentioned above, plug frame 14 can be used to connect to a plurality of different front bodies. Accordingly, in this embodiment, the same plug frame 16 is connected to front body 116 instead of first front body 16. Outer shell 116 corresponds to front body 116 and the type of fiber optic receptacle the front body is configured to mate with. Front bodies, such as front bodies 16 and 116, are paired with their corresponding outer shells, such as outer shells 18 and 118.

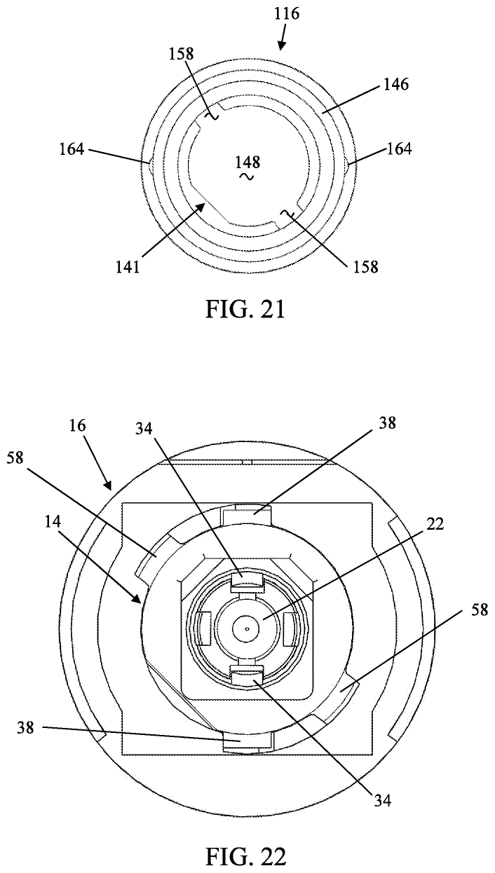

In this embodiment, the front body 116 is configured for mating connection with a type of fiber optic receptacle (e.g., a second type of fiber optic receptacle) that is different from the type of fiber optic receptacle first front body 16 is configured to mate with. In other words, the first and second front bodies 16, 116 have different mating structure for connection to the first type of fiber optic receptacle and the second type of fiber optic receptacle, respectively. Therefore, different types of front bodies, such as front bodies 16, 116, connect to each type of fiber optic receptacle. This difference is reflected in the distal portion of the front body 116 have a different configuration than the distal portion of the first front body 16 in order to connect the front body to its corresponding particular type of fiber optic receptacle. Otherwise, front body 116 is generally the same as first front body 16. For example, front body 116 also includes front body connectors 150. The front body connectors 50, 150 of front bodies 16, 116 are substantially identical in operation (e.g., providing a bayonet connection). Also, front body connectors 150 are generally mirror images of front body connector 50. As a result, front body 116 rotates in one direction to connect the plug frame 14 and first front body 16 rotates in the opposite direction to connect to the plug frame. In one embodiment, the front body connectors 50, 150 may be identical. In addition, in this embodiment, the key 141 of the front body 116 for mating with the key 40 of the plug frame is shown in FIG. 21.

In this embodiment, the outer shell 118 includes exterior threads to for connecting (e.g., threading) the outer shell to corresponding threads (not shown) of the fiber optic receptacle (e.g., second type of fiber optic receptacle).

In one embodiment, the fiber optic connection assembly 10, 110 may come as a kit that includes the fiber optic connector 12, the plug frame 14, and two or more different types of front bodies, such as first and second front bodies 16, 116 and their corresponding outer shells 18, 118. This way, the end user can pick the type of front body 16, 116 for the particular application (e.g., type of fiber optic receptacle) and attach to selected front body (and corresponding outer shell) to the plug frame 14. In this manner, the end user can construct the fiber optic connection assembly 10, 110 that can mate with the particular connection system being used by their customers.

Modifications and variations of the disclosed embodiments are possible without departing from the scope of the invention defined in the appended claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fiber optic connector kit comprising:
a fiber optic connector having a back body and a ferrule supported by the back body and configured to form an optical connection;
a plug frame configured to attach to the back body of the fiber optic connector, the plug frame having a plug frame connector thereon;
a first front body configured for mating connection with a first type of fiber optic receptacle, the first front body including a first front body connector configured to connect to the plug frame connector to connect the first front body to the plug frame; and
a second front body configured for mating connection with a second type of fiber optic receptacle, the first and second front bodies having different mating structure for connection to the first type of fiber optic receptacle and the second type of fiber optic receptacle, respectively, the second front body including a second front body connector configured for connection to the plug frame connector to connect the second front body to the plug frame.

2. The fiber optic connector kit of claim 1 further comprising:
a first outer shell configured to be received on the first front body for rotation relative to the first front body, the first outer shell having a first securing structure for mechanically securing the fiber optic connector to first type of fiber optic receptacle; and
a second outer shell configured to be received on the second front body for rotation relative to the second front body, the second outer shell having a second securing structure for mechanically securing the fiber optic connector to the second type of fiber optic receptacle.

3. The fiber optic connector kit of claim 1, wherein the first front body connector and the second front body connector are substantially identical.

4. The fiber optic connector kit of claim 1, wherein the plug frame connector includes a protrusion and wherein the first and second front body connectors each include a detent configured to engage the at least one protrusion to secure the first or second front body to the plug frame.

5. The fiber optic connector kit of claim 4, wherein the detent forms a snap-fit connection with the protrusion.

6. The fiber optic connector kit of claim 5, wherein the detent is resiliently deflectable.

7. The fiber optic connector kit of claim 1, wherein the first front body connector and the second front body connector each comprise a bayonet flange.

8. The fiber optic connector kit of claim 4, wherein the first and second front bodies each define a lead-in channel sized and shaped to receive the protrusion, the protrusion moving in the lead-in channel toward the detent when the first or second front body is being connected to the plug frame.

9. The fiber optic connector kit of claim 8, wherein the first and second front bodies are each configured to be rotated relative to the plug frame to releasably connect the first or second front body connector to the plug frame connector.

10. The fiber optic connector kit of claim 8, wherein the first and second front bodies are each configured to be rotated relative to the plug frame to move the channel out of alignment with the protrusion and move the detent toward the protrusion.

11. A plug frame for a fiber optic connector, the plug frame comprising:
a plug frame body configured to attach to the fiber optic connector, the plug frame body defining a ferrule lumen sized and shaped to receive a ferrule of the fiber optic connector when the plug frame body is attached to the fiber optic connector;
at least one plug frame connector configured to form a connection with a front body to connect the front body to the plug frame.

12. The plug frame of claim 11, wherein the plug frame connector comprises a protrusion extending outward from the plug frame body.

13. The plug frame of claim 12, wherein the at least one plug frame connector includes two plug frame connectors.

14. The plug frame of claim 13, wherein the two plug frame connectors are disposed on opposite sides of the plug frame body.

15. The plug frame of claim 14, wherein each of the plug frame connectors comprises a protrusion.

16. The plug frame of claim 11, wherein the plug frame body includes a key configured to permit the front body to be connected to the plug frame only when the front body is in a particular orientation relative to the plug frame.

17. The plug frame of claim 16, wherein the key includes a generally planar surface.
